(19) United States
(12) Patent Application Publication
(10) Pub. No.: US 2008/0159624 A1
(43) Pub. Date: Jul. 3, 2008

(54) Texture-based pornography detection

(75) Inventors: Sriram J. Sathish, Bangalore (IN); Srinivasan H. Sengamedu, Bangalore (IN)

Correspondence Address: HICKMAN PALERMO TRUONG & BECKER LLP/Yahoo! Inc., 2055 Gateway Place, Suite 550, San Jose, CA, 95110-1083, US

(73) Assignee: Yahoo! Inc.

(21) Appl. No.: 11/715,051

(22) Filed: Mar. 6, 2007

(30) Foreign Application Priority Data
Dec. 27, 2006 (IN) 2812/DELNP/2006

(51) Int. Cl. G06K 9/00

(52) U.S. Cl. 382/170

(57) ABSTRACT

Techniques are described herein for detecting pornographic content in digital image data by analyzing the texture of the digital image data, and as a result of analyzing the texture of digital image data, designating the digital image as being pornographic or otherwise containing adult or offensive content.

### RELATED APPLICATION DATA

This application is related to and claims the benefit of priority from Indian Patent Application No. 2812/DELNP/2006, entitled “Texture-Based Pornography Detection,” filed Dec. 27, 2006 (Attorney Docket Number 50269-0860), the entire disclosure of which is incorporated by reference as if fully set forth herein.

This application is related to Indian Patent Application No. 2810/DELNP/2006, entitled “Part-Based Pornography Detection,” filed Dec. 27, 2006 (Attorney Docket Number 50269-0828), the entire disclosure of which is incorporated by reference as if fully set forth herein.

This application is related to U.S. patent application Ser. No. ______ (Attorney Docket Number 50269-0829), entitled “Part Based Pornography Detection,” filed herewith, the entire disclosure of which is incorporated by reference as if fully set forth herein.

This application is related to Indian Patent Application No. 2916/DEL/2005, entitled “Method And Mechanism For Analyzing the Texture of a Digital Image,” filed Oct. 31, 2005 (Attorney Docket Number 50269-0646), the entire disclosure of which is incorporated by reference as if fully set forth herein.

This application is related to U.S. patent application Ser. No. 11/316,728, entitled “Method And Mechanism For Analyzing the Texture of a Digital Image,” filed Dec. 22, 2005 (Attorney Docket Number 50269-0647), the entire disclosure of which is incorporated by reference as if fully set forth herein.

This application is related to Indian Patent Application No. 2918/DEL/2005, entitled “Method And Mechanism For Retrieving Images,” filed Oct. 31, 2005 (Attorney Docket Number 50269-0662), the entire disclosure of which is incorporated by reference as if fully set forth herein.

This application is related to U.S. patent application Ser. No. 11/317,952, entitled “Method And Mechanism for Retrieving Images,” filed Dec. 22, 2005 (Attorney Docket Number 50269-0639), the entire disclosure of which is incorporated by reference as if fully set forth herein.

This application is related to Indian Patent Application No. 897/KOL/2005, entitled “Method And Mechanism For Processing Image Data,” filed Sep. 28, 2005 (Attorney Docket Number 50269-0661), the entire disclosure of which is incorporated by reference as if fully set forth herein.

This application is related to U.S. patent application Ser. No. 11/291,183, entitled “Method And Mechanism for Processing Image Data,” filed Nov. 30, 2005 (Attorney Docket Number 50269-0638), the entire disclosure of which is incorporated by reference as if fully set forth herein.

This application is related to Indian Patent Application No. 2917/DEL/2005, entitled “Method And Mechanism for Analyzing the Color of a Digital Image,” filed Oct. 31, 2005 (Attorney Docket Number 50269-0652), the entire disclosure of which is incorporated by reference as if fully set forth herein.

This application is related to U.S. patent application Ser. No. 11/316,828, entitled “Method And Mechanism for Analyzing the Color of a Digital Image,” filed Dec. 22, 2005 (Attorney Docket Number 50269-0653), the entire disclosure of which is incorporated by reference as if fully set forth herein.

### FIELD OF THE INVENTION

The present invention relates to digital images and, more specifically, to identifying potentially objectionable and/or pornographic images based upon analysis of image texture.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

A digital image is the visual representation of image data. Image data, similarly, is data that describes how to render a representation of an image. The standards and formats for expressing image data are too numerous to fully mention, but several examples include a GIF file, a JPG file, a PDF file, a BMP file, a TIF file, a DOC file, a TXT file, and a XLS file.

Digital images may be used in a variety of contexts and for a variety of purposes. For example, a typical website is comprised of digital images that aid a viewer in navigating the website, such as banners, icons, and buttons. The substantive content of a website also may be expressed using a digital image, e.g., the website may display a photograph, a chart, a map or a graph. Digital photography has also become a popular way for people to take digital photographs, which are examples of digital images. Further, numerous software applications are available for creating and manipulating various kinds of digital images.

Image retrieval systems allow users to use a client to retrieve a set of digital images that match a set of search criteria. For example, many websites allow a user to submit one or more keywords to a server. The keywords are processed by the server to determine a set of images that are associated with the submitted keywords. The server may then display the matching set of images or thumbnail representations of the set images, to the user, on a subsequent webpage.

The presence of large numbers of images displaying pornographic and/or offensive content is troublesome in many respects. Users may not want images containing pornographic content to be displayed in response to a search. Therefore, techniques exist for adult images to be detected prior to being displayed to a user, particularly in the context of returning search results to a user.

One approach to detecting adult images is for a human to manually view each and every image that may be returned as a result of a search and manually flag an image as containing adult content. This flag would be checked when any image is added to a set of potential search results. As a result, a user can specify that a search should not return images with adult content and images containing the flag will not be displayed.

A drawback to this approach is the tremendous amount of time and effort that must be expended to analyze and flag every image on the Internet. It is likely that such an effort would be impossible, given the tremendous amount of image content currently existing on the Internet and the amount added each day.

Another approach to detecting adult images is to identify text associated with a digital image that may indicate a pornographic nature of the digital images. This approach fails where no text exists or where misleading text is associated with the image.

Another approach to detecting adult images prior to returning them in a search result is the use of automated skin-color detection techniques. A drawback to this approach is the large number of false positives generated, as the presence of skin in a digital image may simply be a family photograph at a beach instead of a pornographic image. Also, many automated skin-color detection techniques are not effective with black-and-white images.

Thus, approaches for improving the accuracy in detecting adult content in digital images are desirable.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of a system according to an embodiment of the invention;

FIG. 2 is a block diagram illustrating example image frequency distributions according to an embodiment of the invention;

FIG. 3 is a flowchart illustrating the functional steps of determining whether a digital image is pornographic based on the texture of the digital image according to an embodiment of the invention; and

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Functional Overview

Techniques are discussed herein for detecting pornographic content in digital image data by analyzing the texture of the digital image data, and as a result of analyzing the texture of digital image data, designating the digital image as being pornographic or otherwise containing adult or offensive content. For purposes of this application, the terms “pornography,” “offensive content,” and “adult content” are synonymous and should not be limited to a single type of content. An image may be deemed “pornographic” according to an embodiment of the invention if the image texture is analyzed and the analysis indicates the presence of pornography or other specified content in the digital image.

Digital image data may be analyzed to determine the amount of “clutter,” or texture, exists in the image as defined by the data. In general, texture corresponds to the amount of “activity” in an image. In general, images that are preplanned and posed in artificial conditions have less texture. For example, a family portrait taken in a studio would have little texture, while an image of a person running in a forest would have greater texture. One approach to determining the amount of texture in an image is by characterizing the frequency distribution of the image. According to an embodiment, frequency distribution corresponds to the frequency of change in adjacent pixels of an image, and one approach for detecting the frequency distribution of an image is by processing the image through at least one embodiment of a Gabor filter. The frequency distribution is quantified and the quantification is compared to a control threshold. As a result of the comparison, the image may be identified as pornographic or not pornographic.

According to an embodiment, digital image data is received as input and an image operation is performed on the digital image data to determine a frequency distribution within the image or in two or more sections of the image. The frequency distribution represents the amount of texture in the image. According to an embodiment, this frequency distribution is determined by processing the image through at least one embodiment of a Gabor filter. The frequency distribution is calculated into at least one set of data values. The set or sets of data values comprising the frequency distribution, or texture, are compared to a threshold set of data values that, according to one embodiment, are obtained by analyzing the texture of images known to be pornographic or not pornographic. Based on the comparison, the digital image may be identified as pornographic or not pornographic, or of a first type and second type.

Having described a high level approach of embodiments of the invention, a description of the architecture of an embodiment shall be presented below.

### Architectural Overview

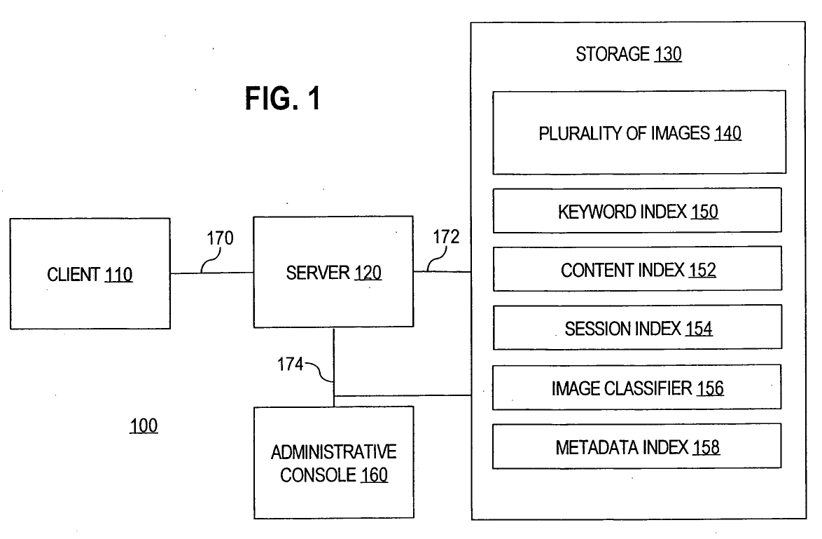

FIG. 1 is a block diagram of a system 100 according to an embodiment of the invention. Embodiments of system 100 may be used to detect digital images that contain pornography or otherwise potentially offensive content by analyzing and comparing the textural content of the digital images. According to an embodiment, a user attempts to search for digital images. A user may specify a variety of different search criteria, e.g., a user may specify search criteria that requests the retrieval of digital images that (a) are associated with a set of keywords, and (b) are similar to a base image. As explained below, if the search criteria reference a base image, some embodiments of system 100 may also consider which digital images were viewed together with the base image by users in a single session when retrieving the requested digital images.

In the embodiment depicted in FIG. 1, system 100 includes client 110, server 120, storage 130, a plurality of images 140, keyword index 150, a content index 152, a session index 154, an image classifier 156, a metadata index 158, and an administrative console 160. Image classifier 156 may be implemented as a single image classifier or may comprise multiple image classifiers. While client 110, server 120, storage 130, and administrative console 160 are each depicted in FIG. 1 as separate entities, in other embodiments of the invention, two or more of client 110, server 120, storage 130, and administrative console 160 may be implemented on the same computer system. Also, other embodiments of the invention (not depicted in FIG. 1), may lack one or more components depicted in FIG. 1, e.g., certain embodiments may not have a administrative console 160, may lack a session index 154, or may combine one or more of the keyword index 150, the content index 152, and the session index 154 into a single index.

Client 110 may be implemented by any medium or mechanism that provides for sending request data, over communications link 170, to server 120. Request data specifies a request for one or more requested images that satisfy a set of search criteria. For example, request data may specify a request for one or more requested images that are each (a) associated with one or more keywords, and (b) are similar to that of the base image referenced in the request data. The request data may specify a request to retrieve a set of images within the plurality of images 140, stored in or accessible to storage 130, which each satisfy a set of search criteria. The server, after processing the request data, will transmit to client 110 response data that identifies the one or more requested images. In this way, a user may use client 110 to retrieve digital images that match search criteria specified by the user. While only one client 110 is depicted in FIG. 1, other embodiments may employ two or more clients 110, each operationally connected to server 120 via communications link 170, in system 100. Non-limiting, illustrative examples of client 110 include a web browser, a wireless device, a cell phone, a personal computer, a personal digital assistant (PDA), and a software application.

Server 120 may be implemented by any medium or mechanism that provides for receiving request data from client 110, processing the request data, and transmitting response data that identifies the one or more requested images to client 110. Server 120 may also contain a processor for executing instructions comprising at least one image classifier 156, and image classifier 156 may be stored on and/or implemented as part of server 120. A processor for executing instructions comprising image classifier 156 may also be implemented as a separate module.

Storage 130 may be implemented by any medium or mechanism that provides for storing data. Non-limiting, illustrative examples of storage 130 include volatile memory, non-volatile memory, a database, a database management system (DBMS), a file server, flash memory, and a hard disk drive (HDD). In the embodiment depicted in FIG. 1, storage 130 stores the plurality of images 140, keyword index 150, content index 152, session index 154, image classifier 156, and the metadata index 158. In other embodiments (not depicted in FIG. 1), the plurality of images 140, keyword index 150, content index 152, session index 154, image classifier 156, and the metadata index 158 may be stored across two or more separate locations, such as two or more storages 130.

Plurality of images 140 represent images that the client 110 may request to view or obtain. Keyword index 150 is an index that may be used to determine which digital images, of a plurality of digital images, are associated with a particular keyword. Content index 152 is an index that may be used to determine which digital images, of a plurality of digital images, are similar to that of a base image. A base image, identified in the request data, may or may not be a member of the plurality of images 140. Session index 154 is an index that may be used to determine which digital images, of a plurality of digital images, were viewed together with the base image by users in a single session. The image classifier 156 is a software module, or set of instructions, that when executed perform steps as described herein. The image classifier 156 may be stored in computer memory, in one file or in several files. According to an embodiment, a classifier is a software program that is constructed for the purpose of classifying input objects into a set of categories. The categories are specified during a construction phase of the classifier called the training phase and the process of classifier construction is called training. During the training phase, exemplary objects for each of the various object categories are given to the classifier and the classifier “learns” the characteristic properties of the objects belonging to each category that would help the classifier in the classification process. A classifier is said to have good generalization property if the classifier is able to categorize objects not seen by it by far into their correct categories, making few errors in the process. The classification and generalization properties of a classifier are determined by the “features” that the classifier is presented with during the training phase. Feature extraction is a key operation in classification, where the task is to extract characteristic properties of input objects that would be of help in discriminating between objects of one class from those of the others.

Administrative console 160 may be implemented by any medium or mechanism for performing administrative activities in system 100. For example, in an embodiment, administrative console 160 presents an interface to an administrator, which the administrator may use to add digital images to the plurality of images 140, remove digital images from the plurality of images 140, create an index (such as keyword index 150, content index 152, session index 154, or metadata index 158) on storage 130, or configure the operation of server 120 or the plurality of classifiers 156.

Communications link 170 may be implemented by any medium or mechanism that provides for the exchange of data between client 110 and server 120. Communications link 172 may be implemented by any medium or mechanism that provides for the exchange of data between server 120 and storage 130. Communications link 174 may be implemented by any medium or mechanism that provides for the exchange of data between administrative console 160, server 120, and storage 130. Examples of communications links 170, 172, and 174 include, without limitation, a network such as a Local Area Network (LAN), Wide Area Network (WAN), Ethernet or the Internet, or one or more terrestrial, satellite or wireless links.

### Texture-Based Pornography Detection

According to an embodiment, the texture of a digital image as defined by digital image data is determined and compared to a threshold value determined by analyzing subject digital images of a known type, such as pornographic or not. Based on the comparison, the subject digital image may be classified as pornographic or not or of a first type or second type.

Digital images have a property known as “clutter,” or “texture.” In general, the amount of clutter in an image corresponds to the amount of activity or confusion in the image. Images that are preplanned, posed, and taken in controlled environments are less likely to have a high degree of texture. It has been observed that pornographic images, such as images containing nude subjects, or subjects engaged in sex acts, or subjects with a mode of dress or comportment that may be described as pornographic, or offensive, or adult content, contain less texture than non-pornographic images. While there is some degree of mischaracterization, this observation may be part of a technique to analyze the texture of a digital image and determine whether or not the digital image is pornographic, according to techniques described herein.

For example, an image with a nude model in front of a forest would likely have a high degree of texture, and may mistakenly be identified as non-pornographic, especially if the model is small compared to the scene in the image. Likewise, a highly posed image with little texture, such as a family portrait, may mistakenly be identified as pornographic. However, according to techniques described herein, an image classifier analyzes digital images for texture and quantifies the result. The quantification may be embodied in a set of data values that are used to determine a value such as a “texture score.” This quantification is compared to a threshold value that, according to an embodiment, has been determined by analyzing thousands of control images of known content or type. As a result, the techniques described herein have a high degree of accuracy with regard to identifying images as pornographic or non-pornographic, for example.

The texture of a digital image may be characterized in several ways. According to an embodiment, an edge-detection approach, such as a wavelet approach, may be utilized to determine the amount of texture in an image. According to an embodiment, in a wavelet approach, wavelet edge moments are used for distinguishing pornographic images from non-pornographic images. In the first step, the wavelet transform is applied to perform multidirectional and multiscale edge detection. Once the edge moments are computed, normalized central moments up to order 5 and the translation, rotation and scale invariant moments based on the gray scale edge image are used to characterize the shape of objects occurring in the images implicitly. The method relies on the assumption that the shape information (characterized by the edge moments) occurring in pornographic images will be different from those in the non-pornographic images.

According to an embodiment, an edge-detection approach such as a wavelet approach identifies edge pixels in an image. The greater the number of edge pixels, the greater the amount of texture in the image. For example, an image of a person will have few edge pixels, and those that exist will generally be crisp. This corresponds to less texture. An image of a forest will have many edge pixels with fine variations, and this corresponds to higher texture. The number of edge pixels in a fixed-size region indicates a degree of texture, or how “busy” that region is, and the direction of the edges may also indicate the degree of texture in an image. According to an embodiment, edge detection techniques may be used alone or in concert with other approaches to analyze the texture of a digital image.

According to an embodiment, an approach for characterizing the texture of a digital image is by processing the image through one or more variations of a Gabor filter. According to an embodiment, Gabor filters may be used alone or in concert with edge detection techniques to analyze the texture of a digital image. In general, a Gabor filter is the product of a Gaussian filter with oriented sinusoids. Gabor filters respond strongly at points in an image where there are components that locally have a particular spatial frequency and orientation. According to an embodiment, by applying variations of Gabor filters at one or multiple scales, orientations and spatial frequencies, a digital image may be analyzed into a detailed local description. For example, a digital image may be analyzed to determine a frequency distribution within the digital image and characterize the frequency distribution of an image into, for example, low and high frequency components.

According to an embodiment, a Gabor filter approach to analyzing the frequency distribution of an image or particular areas within an image may be utilized to quantify the texture of the image and the quantified texture may be utilized by a classifier to identify pornographic or non-pornographic images. According to an embodiment, the frequency distribution of an image is analyzed to determine the frequencies distributed in low and high frequency components. These frequency distributions are input to a classifier trained with frequency distributions from pornographic and non-pornographic images. Based on prior knowledge from training and the new data from the test image, the classifier recognizes that the frequency distribution of the test image is similar to that of the objects from a certain class; for example, the class of pornographic images, and assigns a texture score to the image. By inspecting the score, it is possible to say that the image is pornographic, or otherwise. In an embodiment, the higher the texture score, the more likely the image is to be pornographic and vice versa.

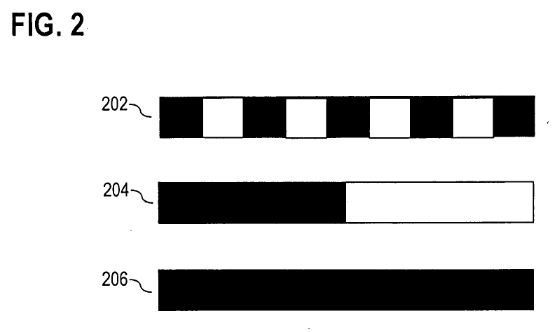

FIG. 2 is a block diagram illustrating example image frequency distributions according to an embodiment of the invention. According to an embodiment, the frequency of a line in a digital image corresponds to the number of times a pixel varies from adjacent pixels in the image; for example, pixels on a single line of an image, whether the line be vertical, horizontal or diagonal, or pixels within a constrained area of an image. In the field of signal processing, the frequencies occurring in a signal (like a line in an image) are represented using sinusoids which are a family of curves or signals each with a single unique frequency. Any general signal is then represented as a weighted sum of sinusoids corresponding to the frequencies that the signal contains. The weight given to a particular sinusoid is determined by the proportion of the signal energy contained in the sinusoid. Different signals will have different distributions of their energy in the sinusoids and therefore different weights. Signals that are similar will have similar distribution of their energies in the various sinusoids and this fact allows one to employ the frequency distribution of energy as a means of comparing signals and by extension, images, which are capable of being defined as two dimensional signals. According to an embodiment, an approach for performing the above is to identify different frequency intervals of a signal (or image) and find the fractional energy in these intervals. A Gabor function and/or filter allow the computation of the signal energy in isolated frequency intervals.

For example, a totally solid image would have no variation between pixels. The frequency of change is very small, and the image would therefore have a very low frequency distribution, and therefore very low texture. A line of pixels with alternating color pixels 202 would have a very high frequency of change and therefore a high frequency distribution for the line in the image. If the image contains enough lines with high a high frequency of change, then the image would have a high texture.

A line of pixels where the first half are one color and the second half are another color 204 would have a lower frequency distribution than the line of pixels with alternating color pixels 202 and therefore less texture. A solid line of pixels 204 would have a lower frequency distribution than the line of pixels with alternating color pixels 202 and the line of pixels where the first half are one color and the second half are another color 204, and therefore less texture.

According to an embodiment, it has been observed that pornographic images tend to have low texture, or “clutter,” and much less change across the image as compared to non-pornographic images. Most of the energy in pornographic images is concentrated in the low-frequency component, while non-pornographic images tend to have greater variation between pixels and more energy concentrated in the high-frequency component.

According to an embodiment, one or more image classifiers are provided that accept digital images as input, analyze the texture of the image, and determine whether the image is pornographic or not. According to an embodiment, the classifiers are software programs or instructions capable of being executed by a computer processor. A classifier is “trained” by taking a set of digital images known to be pornographic or non-pornographic, using these images as input to the classifier, analyzing the frequency distributions of these images, thereby quantifying the texture of the images, and using machine learning techniques to train the classifier to identify similar aspects of other images. After training the classifier, given a new image, the classifier is able to utilize aspects of the teaching input to detect whether the new image is pornographic or not. According to an embodiment, this is accomplished by analyzing the frequency distribution of the images according to techniques described herein, calculating a set of data values based on or comprising the frequency distributions, and comparing the data values to arrive at a determination. Part of the approach may include using the data values representing the texture determination to arrive at a single value such as a texture score. According to an embodiment, the data values are the texture score. The new image may be input by a user, or downloaded from a web page where it is displayed, as part of an indexing process. According to an embodiment, a support vector approach can be trained using Gabor texture features from pornographic and non-pornographic images and the trained classifier can be used to classify new images. According to an embodiment, the classification process can be done by a k-Nearest Neighbor classifier which, for Gabor features from a given new image, finds k closest neighbors from the training set (comprising of features from both pornographic and non-pornographic images) and assigns the new image to the class of the majority of neighbors.

According to an embodiment, a classifier is comprised of one or more Gabor filters, and received a digital image as input. An operation is performed on the digital image, such as the digital image being processed by the Gabor filters, and information about the various radiance measurements of various frequency regions in the image is encoded, for example in one or more data sets. Given an image and a Gabor filter, one may ascertain the texture of the image in regions of the image characterized by the Gabor filter.

According to an embodiment, the image is processed by one or more Gabor filters and one or more numerical data sets or data values are generated describing the texture of the image as defined by the frequency distributions within the image. The data values are compared to threshold values generated as described above, and based on the comparison, a determination is made regarding whether the image is pornographic or not. According to an embodiment, a classifier receives as input the data generated as a result of processing the digital image through the one or more Gabor filters, and predicts the image into a class, such as whether the image is pornographic or not. According to an embodiment, a classifier receives as input data generated as a result of processing the digital image through an edge detection technique and/or at least one Gabor filter, and predicts the image into a class, such as whether the image is pornographic or not.

According to an embodiment, the results of processing the image through at least one Gabor filter are used to calculate a value, such as a “texture score,” that is compared to a threshold value, such as a “texture threshold,” and as a result of the comparison, the image is classified as a particular type, such as pornographic.

According to an embodiment, a percentage of skin exposure or skin content in the image is determined and based on this determination, a score reflecting the determination is calculated and compared to a threshold value as part of the texture comparison as described above. For example, one embodiment of the comparison would be: “If (skin_percentage<SKIN_THRESHOLD) AND (gabor_texture_score<TEXTURE_THRESHOLD) THEN decide image is non-pornographic.” Another example would be “If (skin_Percentage>SKIN_THRESHOLD) AND (gabor_texture_score>TEXTURE_THRESHOLD) THEN decide image is pornographic.” According to an embodiment, an image may be reduced in size and/or subdivided into subimages prior to processing by a classifier. For example, a 100×100 image may be subdivided into several 20×20 subimages and these subimages processed by the one or more classifiers.

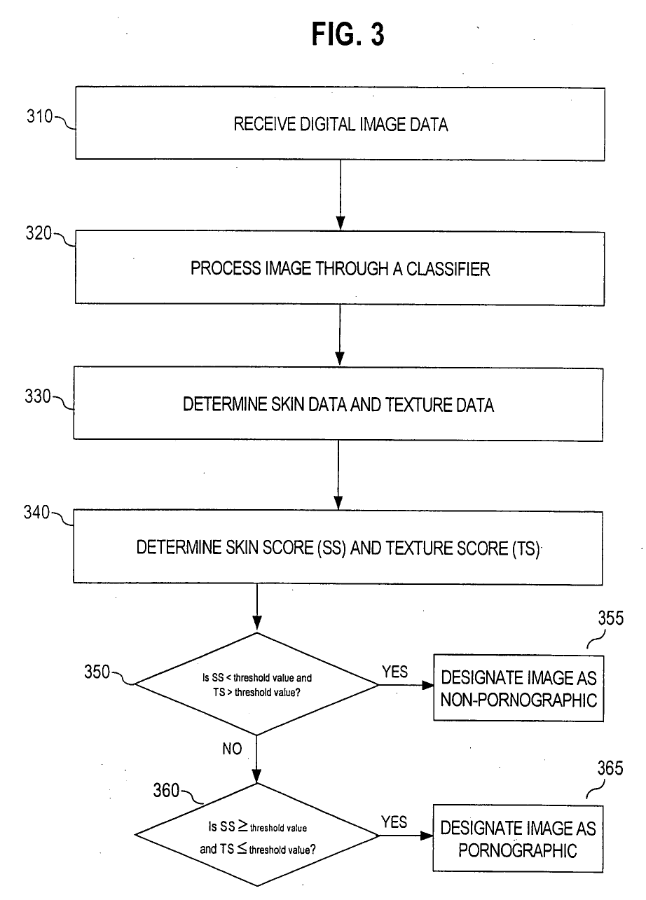

FIG. 3 is a flowchart illustrating the functional steps of identifying pornographic images, according to an embodiment of the invention. The particular sequence and number of steps illustrated in FIG. 3 is merely illustrative for purposes of providing a clear explanation. Other embodiments of the invention may perform all, more, or a subset of the steps of FIG. 3 in order, in parallel, or in a different order than that depicted in FIG. 3.

In step 310, digital image data defining a digital image is received. The digital image data may be a separate data file loaded into an embodiment for the purpose of classification, or may be digital image data obtained from one or more web pages, for example during a web spidering or archiving process. In step 320, the digital image data is analyzed by processing the digital image data through one or more classifiers, as described herein.

In step 330, a percentage of skin exposure or skin content in the image is determined as described herein, and the textural features of the image are determined as described herein. According to an embodiment, the skin data and texture data may comprise a set of data values, and these data values may be determined by the one or more classifiers or by a separate element that receives data from the one or more classifiers. In step 340, based on the data values representing or defining the skin data and texture data of the digital image, a skin score (SS) and texture score (TS) are computed for the image. In step 350, it is determined whether SS is less than a threshold value and TS is greater than a threshold value, and if so, then the image is designated as pornographic. The comparison may require both elements to be true or only one. The threshold value may be predetermined or computed based on a classification of images that are known to be pornographic or nonpornographic. The threshold values may be based on the machine learning described herein and may be edited, for example, by a user. According to an embodiment, the comparison between the threshold values and the skin score and texture score is not a numerical comparison, but a comparison of one or more sets of data values wherein similarities and differences between the data values are determined, and based on the determination, a result is obtained.

In step 350, it is determined whether SS is greater than or equal to a threshold value and whether TS is less than or equal to a threshold value, and if so, then the image is designated as pornographic. Embodiments are not limited to the comparisons described above, as any type of comparison involving skin data and/or texture data may be utilized to designate an image as pornographic or nonpornographic. According to an embodiment, an image may be designated as an unknown type as a result of the comparison between data values.

### Hardware Overview

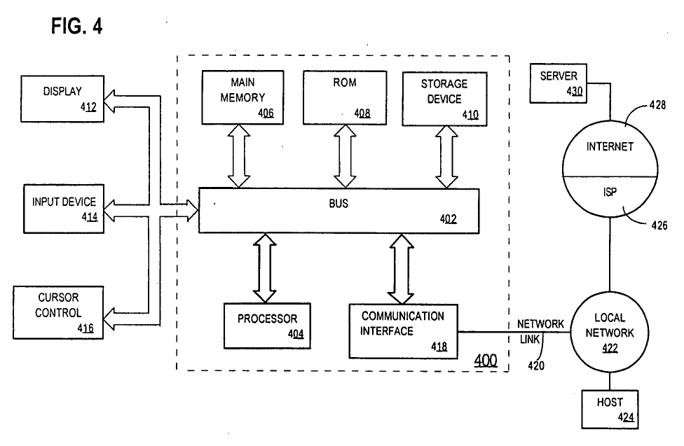

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 400, various machine-readable media are involved, for example, in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the worldwide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the of such claim in any way. The specification and drawings are, accordingly, to be regarded in an illustrative rather than a restrictive sense.

What is claimed is:

1. A computer-implemented method for identifying pornographic images, the computer-implemented method comprising:
receiving digital image data that defines a digital image;
analyzing the digital image data to determine a frequency distribution within the digital image, wherein the frequency distribution within the digital image is represented by a first set of data values;
comparing the first set of data values to a threshold set of data values;
based on the comparison, designating the digital image as a first type or a second type.

2. The computer-implemented method of claim 1 wherein the first type designates pornography and the second type designates non-pornography.

3. The computer-implemented method of claim 1 wherein analyzing the digital image data further comprises:
processing the digital image data through two or more Gabor filters, wherein each of the Gabor filters is configured to compute the signal energy in isolated frequency intervals within the image data;
representing the frequencies occurring in the digital image data with sinusoids; and
calculating the set of data values based on a weighted sum of the sinusoids corresponding to the frequencies, wherein the weight given to a particular sinusoid is determined by the proportion of signal energy defined by the sinusoid.

4. The computer-implemented method of claim 1 wherein the digital image is obtained from one or more web pages.

5. The computer-implemented method of claim 1 further comprising resizing the digital image.

6. The computer-implemented method of claim 1 wherein analyzing the digital image data includes:
processing the digital image data through at least one Gabor filter.

7. The computer-implemented method of claim 1 wherein analyzing the digital image data includes:
processing the digital image data through more than one Gabor filter;
for each Gabor filter, calculating a set of data values that characterizes a frequency distribution of the digital image;
comparing each set of data values to the threshold set of data values;
based on the comparison, designating the digital image as a first type or a second type.

8. The computer-implemented method of claim 1 further comprising:
determining a percentage of skin exposure in the digital image;
comparing the percentage of skin exposure in the digital image to a threshold percentage;
based on the comparing the percentage of skin exposure in the digital image to a threshold percentage and the comparing the first set of data values to a threshold set of data values, designating the digital image as the first type or the second type.

9. The computer-implemented method of claim 1 wherein analyzing the digital image comprises determining a radiance of frequency regions in the digital image.

10. The computer-implemented method of claim 1 wherein the threshold set of data values is determined by analyzing frequency distributions of a group of digital images designated to be non-pornographic.

11. The computer-implemented method of claim 1 wherein comparing the first set of data values to a threshold set of data values comprises analyzing the first set of data values to determine whether the digital image depicts offensive content.

12. A computer-readable medium carrying instructions which, when executed by one or more processors, causes:
receiving digital image data that defines a digital image;
analyzing the digital image data to determine a frequency distribution within the digital image, wherein the frequency distribution within the digital image is represented by a first set of data values;
comparing the first set of data values to a threshold set of data values;
based on the comparison, designating the digital image as a first type or a second type.

13. A computer-readable medium carrying one or more sequences of instructions which, when executed by one or more processors, causes the one or more processors to perform the method recited in claim 2.

14. A computer-readable medium carrying one or more sequences of instructions which, when executed by one or more processors, causes the one or more processors to perform the method recited in claim 3.

15. A computer-readable medium carrying one or more sequences of instructions which, when executed by one or more processors, causes the one or more processors to perform the method recited in claim 4.

16. A computer-readable medium carrying one or more sequences of instructions which, when executed by one or more processors, causes the one or more processors to perform the method recited in claim 5.

17. A computer-readable medium carrying one or more sequences of instructions which, when executed by one or more processors, causes the one or more processors to perform the method recited in claim 6.

18. A computer-readable medium carrying one or more sequences of instructions which, when executed by one or more processors, causes the one or more processors to perform the method recited in claim 7.

19. A computer-readable medium carrying one or more sequences of instructions which, when executed by one or more processors, causes the one or more processors to perform the method recited in claim 8.

20. A computer-readable medium carrying one or more sequences of instructions which, when executed by one or more processors, causes the one or more processors to perform the method recited in claim 9.

21. A computer-readable medium carrying one or more sequences of instructions which, when executed by one or more processors, causes the one or more processors to perform the method recited in claim 10.

22. A computer-readable medium carrying one or more sequences of instructions which, when executed by one or more processors, causes the one or more processors to perform the method recited in claim 11.

23. A method comprising performing a machine-executed operation involving instructions, wherein the machine-executed operation is at least one of:
A) sending the instructions over transmission media;
B) receiving the instructions over transmission media;
C) storing the instructions onto a machine-readable storage medium; and
D) executing the instructions;
wherein the instructions are instructions which, when executed by one or more processors, cause the one or more processors to perform steps comprising:
receiving as input digital image data defining a digital image;
processing, by a classifier, the digital image data, wherein the classifier is configured to:
determine one or more sets of data values representing the amount of skin displayed in the digital image;
process the digital image data through one or more Gabor filters, wherein the one or more Gabor filters are each configured to determine a frequency distribution within one or more sections of the digital image, wherein the frequency distributions are represented by one or more sets of data values;
determining score values based on the one or more sets of data values representing the amount of skin displayed in the digital image and the one or more sets of data values representing the frequency distributions;
comparing the score values to threshold values, wherein the threshold values are determined by evaluating images of a first and second type; and
based on the comparison, designating the digital image as the first type or the second type.
